(19) United States
(12) Patent Application Publication
(10) Pub. No.: US 2006/0020816 A1
(43) Pub. Date: Jan. 26, 2006

(54) Method and system for managing authentication attempts

(76) Inventor: John Robertson Campbell, Ottawa (CA)

Correspondence Address: TORYS LLP, 79 WELLINGTON ST. WEST, SUITE 3000, TORONTO, ON, M5K 1N2, CA

(21) Appl. No.: 11/172,899

(22) Filed: Jul. 5, 2005

Related U.S. Application Data
(60) Provisional application No. 60/585,845, filed on Jul. 8, 2004.

(51) Int. Cl. H04L 9/00

(52) U.S. Cl. 713/182

(57) ABSTRACT

The present invention provides, in certain embodiments, identification and management of authentication attempts using having a real time communication channel with the end user that is separate from the channel being used for authentication. An example is where Internet users are a) identified by their cell phone numbers and may b) access the internet from many different physical locations. Aspects of the invention allow for authentication issue detection to be extended, utilizing the separate communication channel to communicate directly with the user. This can allow the authenticating authority to take proactive action on a more automatic basis with the ability to distinguish fraud or abuse attempts from user problems aided by the separate communication channel.

### PRIORITY CLAIM

The present application claims priority from U.S. Provisional Patent Application No. 60/585,845, filed Jul. 8, 2004, the contents of which are incorporated herein by reference.

### FIELD OF THE INVENTION

The present invention relates generally to computer authentication and more particularly relates to a method and system for managing authentication attempts.

### BACKGROUND OF THE INVENTION

Authentication of users and the like in computing environments is an important aspect of providing secure computing environments. Such authentication should be rigid enough to provide reasonable assurance that only authorized users can access the computing environment, and yet should not be so onerous that the user finds it impractical to actually gain access to the computing environment.

### SUMMARY OF THE INVENTION

Aspects of the present of this invention take effective action to manage invalid authentication attempts through pattern analysis and the use of a separate communication channel to communicate with Users in real time. Such invalid authentication attempts could include fraudulent or abusive situations as well as a lack of User knowledge.

The identification and management of authentication attempts can be improved in a unique way by having a real time communication channel with the end user that is separate from the channel being used for authentication. An example of this is where Internet users are a) identified by their cell phone numbers and may b) access the internet from many different physical locations. Aspects of the invention allow for authentication issue detection to be extended with superior action compared to prior art, utilizing the separate communication channel to communicate directly with the user. This can allow the authenticating authority to take more proactive action on a more automatic basis with the ability to distinguish fraud or abuse attempts from user problems aided by the separate communication channel.

Aspects of the invention involve managing access to the internet, or a network. Another aspects involve managing access to an application, such as an internet connected web application.

### BRIEF DESCRIPTION OF THE DRAWINGS

Embodiments of the present invention will now be described by way of example only with reference to the attached figures herein.

FIG. 1 is a system block diagram of a system for managing attempted illegitimate authentication attempts in accordance with another embodiment of the invention;

FIG. 2 is a flow chart of a method for managing attempted illegitimate authentication attempts in accordance with another embodiment of the invention; and,

FIG. 3 is a flow chart of a method for managing attempted illegitimate authentication attempts in accordance with another embodiment of the invention.

### DETAILED DESCRIPTION OF THE INVENTION

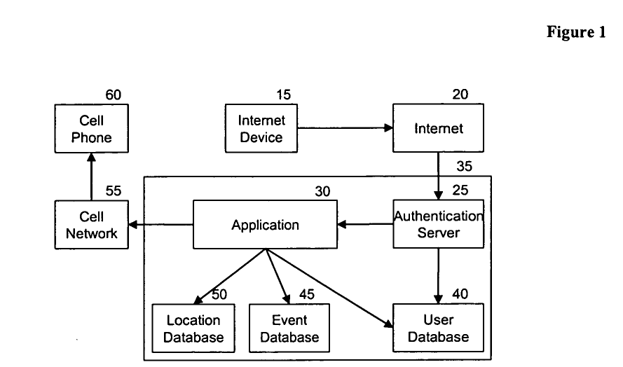

Referring to FIG. 1, the system for managing authentication attempts is generally located at 35. The System 35 includes an authentication application or Authentication Server 25, which, for example, could be implemented with a RADIUS server. The System also includes a User Database 40, which could be many different standards and products. The System also includes an Event Database 45 which is used to store information about authentication events such as User ID, location of authentication attempt, time of attempt, if password matched User ID. The Location Database 50 stores information about the geographic coordinates of access locations and the type of access location (e.g. airport). The System also contains an Application 30 which can interface with the databases, the Authentication Server and the Cellular Network 55. The System may be contained in any kind of computer that has suitable processing power, RAM, Disc capacity and communications ports. The computer may run any OS that is compatible with the applications 25, 30, 40, 45, 50.

Users requiring authentication are equipped with internet devices such as a computer, a notebook computer, a PDA or a WLAN enabled cell phone 15. Such devices support internet communication protocols.

These devices are attempting to access the internet from various locations. The access could be via wireless or wired network. The internet equipment 20 at the location is able to block access to the internet until the device 15 has been authenticated. The Internet equipment communicates with the Authentication Server 25 to pass information about the User to the Authentication Server 25. The Internet equipment will not permit the Device to access the network until it has been advised to do so by the Authentication Server. This often takes the form of an “authentication accept” message.

The Authentication Server interfaces to the User Database 40 to compare the User ID and password offered by the Internet Device 15 with that stored in the User Database 40. The Authentication Server passes information about the authentication attempt to the Application and receives a message back from the application indicating if Authentication can proceed. If the authentication may proceed, the Authentication Server will communicate with the Internet equipment to inform the equipment that access may be permitted. This often takes the form of an “authentication accept” message.

The Application 30 receives information about authentication attempts, referred hereafter as “events”, from the Authentication Server 25.

The Application 30 may:
a) Record the event in Even Database (45).
b) Retrieve and analyse information about events when a new event occurs. The Application searches the database and compares the event to criteria. The criteria may include:
   1) Authentication attempt when the same User ID has been used to successfully authenticate an internet access, and said internet access is still active.
   2) Authentication attempt when an attempt using the same User ID occurred from a different location, and the time between the attempts would not allow a legitimate Internet user to travel from the first location to the second. When locations are established, the geographic coordinates (such as UMT coordinates) must be determined. The geographic coordinates are stored in the Location database (50). When an authentication attempt occurs, the Application will search the Location database to determine the geographic location of the current attempt and the geographic location of the most recent successful attempt. The time of most recent successful attempt will be obtained by searching the Event database. Other preferred embodiments may not include location information and the Location database (50).
   3) Multiple authentication attempts using a cellular number (irrespective of location of attempts) within a time period, where the number of attempts and the duration of the time period indicate atypical use.
   4) Multiple authentication attempts from a given location (irrespective of cellular number) within a time period, where the number of attempts and the duration of the time period indicate atypical use.

The Application 30 may make use of a separate communications channel, in this case a cellular network 55, to communicate with a legitimate user via a device they possess, in this case a cellular phone 60.

The Application 30 may perform one or more of the following actions depending upon criteria that may be established in the Application.

1) Automatic action to change the password and inform the legitimate user of the new password. The Application 30 would generate a new password and then a) store the new password in the User Database 40 and b) send the new password to the cellular phone via the Cellular Network 55 using SMS or IVR methods, along with a message explaining the reason a new password is being sent.

2) Automatic action to suspend the account and distribution of passwords. The Application 30 would place the User ID on a Block List in the User database. The Block List would over-ride other Authentication server functions to authenticate, create a new account, or create and distribute new password to the cellular phone 60.

3) In the case of 2) above, or otherwise, automatic action to contact the Internet user via their cellular phone and request them to take/not take action, including requesting them to initiate contact with the service provider. Such contact could be via the Cellular Network 55 using SMS or IVR methods to the legitimate User's cellular phone 60.
4) Notification to personnel so that they may initiate manual action to contact the Internet user via a phone call or SMS message to their cellular number. If contact cannot be made between personnel and the User, and a suitable explanation given by the User, then the account may be suspended or law enforcement agency contacted. If there is a suitable explanation, assistance may be offered to the legitimate user.

Some or all of the functions of the Application may be distributed and be associated with the Authentication Server or other applications such as a web server not necessarily part of this system.

The Event database functions maybe provided in a separate database or combined with other databases that may be part of a system.

The Location database functions maybe provided in a separate database or combined with other databases that may be part of a system.

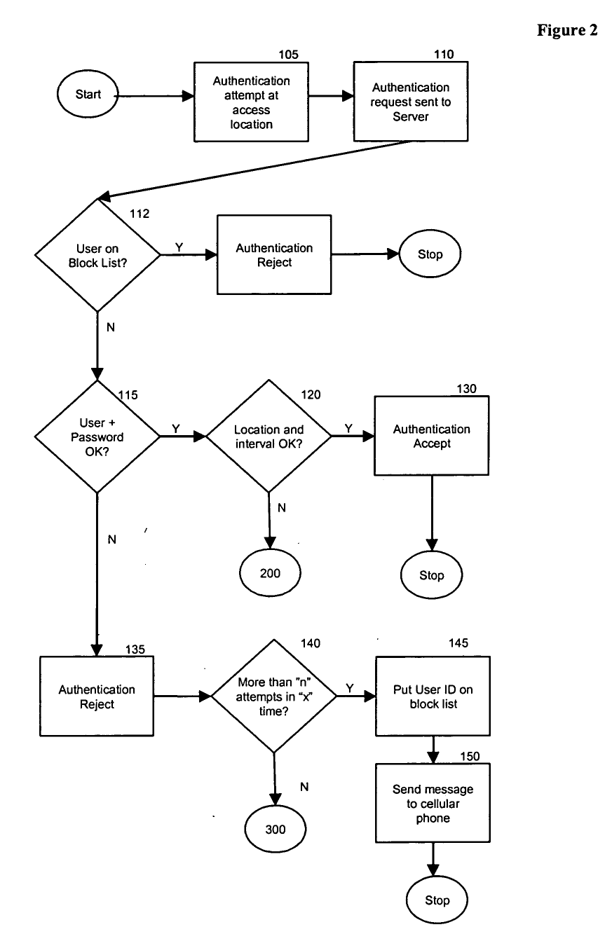

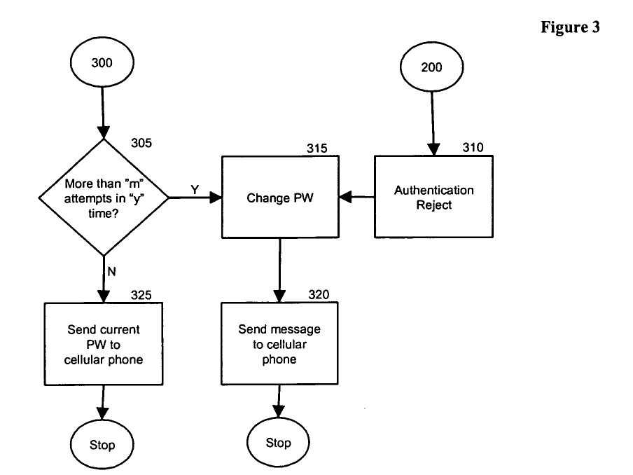

The implementation of the invention could have a logical flow as depicted in FIG. 2 and FIG. 3. This is an example of how a system could function, and others are possible, considering other factors and combinations of these factors in the decisions.

The method starts with an attempt to access the internet at a location (105). Equipment at the location will capture the request and forward it to a centralized Server (110) making use of an authentication protocol such as RADIUS, referred to hereafter as “the authentication protocol”.

The Server will verify if the User ID is on a Block List (112). If the User ID is on the Block list then the Server will proceed with authentication reject using the authentication protocol.

The Server will verify if the User ID and password constitute a valid authentication attempt (115). If it does, the server will then retrieve the geographic coordinates of the current authentication attempt and then retrieve the geographic coordinates and time of the most recent previous valid authentication attempt and calculate the physical distance between the current and most recent previous authentications as well as the time interval between the current and most recent previous authentications. The Server will then apply rules (120) with determine if the implied velocity is reasonable. The rules may include factors such as the distance (such as short vs. long) and type of location (such as airport).

If the Server determines that the implied velocity is acceptable (120) then the Server will proceed with authentication accept (130) using the authentication protocol, allowing the User to gain access to the internet.

If the Server determines that the implied velocity is unacceptable (120) then the Server will then proceed with authentication reject using the authentication protocol preventing internet access associated with this attempt (310). The Server will then create and a new random password for the User and store this new password in the User database, replacing the current password (315).

The Server will then send a message to the valid User (320) by way of an SMS message the User's cellular phone. The cellular phone number may be determined either by searching the User database or, if the service is so designed, the User ID may be the cellular number of the User. Thus the User ID would be the required cellular number. This above approach may be used in any of the following instances where the cellular number of the User is required.

The SMS message sent in step (320) would indicate that the password has been changed and the reason. An example message could read “Your password has been changed to XXXXXXX due to a risk that your old password has been compromised”. Thus the valid user is automatically equipped with and informed of a change in password.

Going back to step (115), if the Server determines that the User ID and password do not constitute a valid pair, the Server will proceed with authentication reject using the authentication protocol preventing internet access associated with this attempt (135).

The Server will then search a database of recent authentication attempts (successful and unsuccessful) and determine (140), as an example, if more than 10 attempts have been made to authenticate in the past 1 hour. This would have the generic form of more than “n” attempts within “x” time interval. If the threshold had been exceeded, then the system would put the User ID on a Block list (145). The Server will then send a message to the valid User (150) by way of an SMS message the User's cellular phone. The SMS message would indicate that the User account has been suspended and request the User to contact the authentication authority. The authentication authority could be a service provider or company that is granting access to, in this case, the internet. An example SMS message could read “Your account has been suspended due to a risk that your password has been compromised. Please contact 800-555-5555 for further information”. Thus the valid user is informed of the issue and can contact the authentication authority.

Returning to step 140, if the threshold had not been exceeded, then the Server would determine (305), as an example, if more than 5 attempts have been made to authenticate in the past 1 hour. This would have the generic form of more than “n” attempts within “x” time interval, but would have a lower threshold than in step 140. If the threshold had been exceeded, then the system would proceed as described above in step 315 and 320.

If at step 305, the threshold had not been exceeded, then the Server would retrieve the current password from the User database and send the current password to valid User (325) by way of an SMS message the User's cellular phone.

The above-described embodiments of the invention are intended to be examples of the present invention and alterations and modifications may be effected thereto, by those of skill in the art, without departing from the scope of the invention which is defined solely by the claims appended hereto.

1) A computer-based system for managing illegitimate authentication attempts comprising:
a first application for receiving an authentication attempt from a device connected to said system; said attempt having been entered into said device by a user; said user being one of a legitimate user and an illegitimate user;
a second application for capturing and recording said authentication attempt;
a third application for performing an analysis of said authentication attempt and for performing a determination of whether said authentication attempt is potentially from said illegitimate user;
a fourth application for modifying an authentication system database based on results from said third application; and
a communication channel to another device associated with said legitimate user and operable to send messages based on results from said third application to said another device for presentation to said legitimate user.

2) The system according to claim 1 wherein said first application is based on RADIUS protocols.

3) The system according to claim 1 wherein an authentication attempt includes a User ID that is based on a non-internet communications system.

4) The system according to claim 3 where the non-internet communications system is a cellular phone, and wherein said User ID is a cellular phone number.

5) The system according to claim 3 where the non-internet communications system is a pager and wherein the User ID is a pager number.

6) The system according to claim 3 wherein the User ID contains the non-internet communications address for the user.

7) The system according to claim 3 wherein the User ID is cross referenced to the non-internet communications address for the User.

8) The system according to claim 1 where said applications are embedded in one or more centralized servers.

9) The system according to claim 1 where said applications are embedded in a self contained authentication device.

10) The system according to claim 4 where said messages are by SMS (Short Message Service).

11) The system according to claim 4 where said messages are by voice.

12) The system according to claim 10 where the SMS is generated by a sixth application.

13) The system according to claim 10 where the SMS is generated by a human.

14) The system according to claim 11 where said voice is generated by an interactive voice response application.

15) The system according to claim 11 where the voice is generated by a human.

16) The system according to claim 1 where the analysis identifies said authentication attempt as having a valid User ID and password while a previously authenticated session is still active and the determination concludes that said authentication attempt was potentially from an illegitimate user.

17) The system according to claim 1 where the analysis identifies an authentication attempt with valid User ID and password while a previously authenticated session is still active.

18) The system according to claim 1 wherein the third application includes permitted geographic coordinates for the locations where said user may authenticate and wherein the analysis identifies actual geographic coordinates of said authentication attempt; and wherein said determination concludes that said authentication attempt was potentially from an illegitimate user if said actual geographic coordinates are outside said permitted geographic coordinates.

19) The system according to claim 1 where the analysis identifies actual geographic coordinates of said authentication attempt and said third application is operable to determine a distance travelled and an elapsed time between said actual geographic coordinates and a previous set of geographic coordinates and a previously successful authentication; and wherein said determination concludes that authentication is potentially from an illegitimate user if at least one of said distance and said elapsed time exceed a predefined threshold.

20) The system according to claim 1 where the analysis includes determining a number of number of previous authentication attempts prior to using a particular User ID prior to said authentication attempt within a time period and the determination concludes said authentication attempt is potentially from an illegitimate user if said time period does not fall within a predefined range.

21) The system according to claim 1 where the analysis includes determining the number of authentication attempts from a particular location within a time period.

22) The system according to claim 3 further comprising a fifth application wherein a password associated with said User ID can be modified and said User notified.

23) The system according to claim 1 wherein any future authentication attempts associated with said user are flagged as illegitimate in said database if said authentication attempt is from a potentially illegitimate user.

24) The system according to claim 1 where the Authentication server may proceed with authentication if the Application has not responded within a defined time and the User ID and password are valid.

25) The system according to claim 1 wherein the authentication system is based on other internet protocols, such as DIAMETER.
